(19) United States
(12) Patent Application Publication
(10) Pub. No.: US 2014/0274145 A1
(43) Pub. Date: Sep. 18, 2014

(54) LOCATION BASED FILTERING OF TARGETED CONTENT FOR MOBILE DEVICES

(71) Applicant: THE HUB COMPANIES, LLC, Denver, CO (US)

(72) Inventors: John M. CRONIN, Breckenridge, CO (US); Kevin Lee QUINN, Breckenridge, CO (US)

(21) Appl. No.: 13/843,474

(22) Filed: Mar. 15, 2013

(51) Int. Cl. H04W 4/02

(52) U.S. Cl. CPC H04W 4/02
USPC 455/456.3

(57) ABSTRACT

Systems and methods are provided for filtering targeted content for a mobile device user located within a designated target region based on the location of the user's mobile device relative a predefined content-filter area of the target region. The predefined content-filter area corresponds to a point of interest located within the target region. When the mobile device is determined not to be located within the predefined content-filter area, content related to the point of interest is requested from a server over a network, and content received from the server in response to the request is displayed to a display of the mobile device.

### BACKGROUND

1. Field

The present disclosure relates generally to mobile location-based services.

2. Background

Modern mobile communication devices and networks allow users to subscribe to various location-based services through their mobile devices. For example, a client application executable at a user's mobile device may be used to provide access to different features of such a service based on a current geographic location of the user's mobile device. For example, a user's mobile device, such as a smart-phone, may be equipped with a Global Positioning System (GPS) for obtaining geographic location data for the device, which can then be used to determine or estimate the geographic location of the mobile device (and user) at a particular moment in time. The mobile device may send the location data via a network to another computing device, for example, a remote server, which in turn determines or estimates the mobile device's (and user's) current geographic location based on the location data received from the device. The other computing device, e.g., remote server, may also host a location-based service that sends targeted content, such as advertisements or other promotional content, via the network to the user's mobile device based on the estimated current geographic location of the mobile device. The targeted content that is sent to the mobile device may include, for example, promotional information related to a business or commercial retail store located near the current geographic location of the mobile device.

### SUMMARY

The disclosed subject matter relates to filtering targeted content for a mobile device user based on a geographic location of the user's mobile device within a target region relative to a designated content-filter area of the target region.

In an example method for filtering targeted content for a mobile device user located within a designated target region, a current geographic location of a mobile device of a user is determined. The current geographic location of the mobile device is then used to determine whether or not the mobile device is located within a target region. The target region includes at least one point of interest. When the mobile device is determined to be located within the target region, another determination is made as to whether or not the mobile device is located within a predefined content-filter area of the target region. When the mobile device is determined not to be located within the predefined content-filter area, a request is sent to a server for content related to the point of interest. Content received from the server in response to request is displayed to a display of the mobile device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Several features of the disclosed subject matter are described, by way of example, with reference to the accompanying drawings. In the drawings, like reference numbers may indicate identical or functionally similar elements.

FIG. 1 is a diagram of an exemplary communication system suitable for practicing an implementation of the subject technology.

FIG. 2 is a diagram of an exemplary mobile device for filtering targeted content for a mobile device user within a target region based on the user's location relative to a designated content-filter zone of the target region.

FIG. 3 illustrates an example of a target region having a content-filter area for filtering targeted content for mobile device users located within the target region.

FIG. 4 illustrates an example of multiple content-filter areas corresponding to different points of interest within a geographic region.

FIG. 5 is a process flowchart of an exemplary method for filtering targeted content for mobile device users based on their current locations relative to a point of interest within a geographic region.

FIG. 6 is a block diagram of an example computer system in which portions of the subject technology can be implemented.

### DETAILED DESCRIPTION

The disclosed subject matter relates to filtering targeted content for a mobile device user located within a particular geographic region of interest based on the location of the user's mobile device relative to a predefined content-filter area of the geographic region. While the present disclosure is described herein with reference to illustrative examples of particular implementations, it should be understood that the present disclosure is not limited thereto and that other implementations are possible. Thus, modifications to the provided examples can be made within the spirit and scope of the teachings herein and additional fields in which the present disclosure would be of significant utility. Further, when a particular feature, structure, or characteristic is described in connection with a particular implementation, it should be possible to effect such feature, structure, or characteristic in connection with other implementations whether or not explicitly described.

In an example, content for a mobile device user located within a particular geographic region is filtered or customized based on a current location of the user's mobile device relative to a predefined content-filter area of the region. The particular geographic region may be designated as a “target region” for providing targeted content for mobile device users located within the region. The target region in this example may be any geographic region designated for providing targeted content to mobile device users based on their respective locations within the region. The target region may be, for example, a particular city, county, state or province of a country. However, the target region is not intended to be limited thereto and may be a geographic area or region of any size and shape that has The boundaries of such a region may be predefined by, for example, a provider of a content delivery service, as will be described in further detail below.

The predefined content-filter area of the target region may correspond to, for example, a particular location or point of interest within the target region. Such a point of interest may be, for example and without limitation, a particular venue (e.g., a concert hall or stadium) or location of a particular event (e.g., concert or sporting event), a hotel, a commercial business or retail store, or a public area or location (e.g., a park or location of a public landmark). However, it should be noted that a point of interest for a corresponding content-filter area, as described herein, may be any predefined location, such as a physical address or pair of geolocation (latitude and longitude) coordinates, within the designated target region.

As will be described in further detail below, a third-party content provider may use a content-filter area of a target region to filter or customize targeted content provided to mobile device users located within the content-filter area relative to other mobile device users within the target region. While the examples provided below will be described with respect to content-filter areas that correspond to points of interest located within a geographic region, it should be noted that the techniques described herein are not intended to be limited thereto and that these techniques may be used with content-filter areas that do not correspond to any point of interest.

The term “content” is used herein to refer generally to any type of digital content that may be sent to a mobile device for processing or display to a user of the device. Such content may include, for example and without limitation, text, graphics, media (including audio, images or video) or any combination thereof. The term “targeted content” is used herein to refer to content that may be customized or tailored to a particular user or group of users, e.g., based, at least in part, on each user's current location relative to a designated content-filter area within a geographic region of interest or target region, as described above and as will be described in further detail below. While some of the examples below will be described in the context of providing targeted content in the form of promotional information or targeted advertisements, it should be noted that the techniques described herein are not intended to be limited thereto. In addition to providing content related to a particular product or service, these techniques may be used to provide other types of targeted content. For example, such other types of targeted content may be provided to mobile device users for educational or informational purposes and may include, but are not limited to, public service announcements, safety advisories, traffic reports, weather updates, and any other information that may be relevant to mobile device users located within a particular geographic region.

In one example, a predefined content-filter area (also referred to herein as a “do-not zone” or “Do-notz”) may be designated for a point of interest corresponding to the location of a particular event (e.g., a stadium, arena or other type of venue for a music concert or sporting event) within a target region (e.g., a particular city or town). However, it should be noted that the techniques described herein are not limited to predefined content-filter areas for particular events or specific points of interest and that these techniques may be applied to any predefined area of a geographic region for filtering or customizing targeted content for mobile device users located within the geographic region. The bounds of the content-filter area in this example may be based on, for example, a geo-fence or virtual perimeter around an exterior or interior portion of the point of interest. The virtual perimeter may correspond to the physical perimeter around an exterior or interior portion of a building or other physical structure corresponding to the point of interest (e.g., a perimeter around an interior seating area of a stadium).

For example, a point of interest located within a particular geographic region (e.g., a particular city or town) may be a venue (e.g., concert hall or stadium) for a particular event (e.g., music concert or sporting event) and the do-not zone corresponding to the point of interest may be a predefined area corresponding to the venue (e.g., interior space of the hall or stadium). The content provider in this example may be an event promoter who would like to send particular content, e.g., promotional information or targeted advertisements, indicating to mobile device users who may be located nearby or in a particular geographic region of interest (e.g., within city limits) that tickets for the event are still available for purchase (e.g., at a reduced price). However, the event promoter also may wish to exclude or send different content (e.g., targeted advertisements related to refreshments or other items available for sale) to those mobile device users who are already in attendance at the event. Accordingly, a do-not zone corresponding to an interior space of the hall or stadium enables the event promoter to filter mobile device users into at least two different affinity groups based on their respective geographic locations relative to the point of interest, namely one group of users who are already attending the event based on their location within the stadium and another group of users who are not at the event. The content provider or event promoter in this example may therefore use a predefined do-not zone to target different groups of mobile device users based on their respective locations so as to provide content that is likely to be more relevant or useful to each particular user given the user's current geographic location.

FIG. 1 is a diagram of an example network system 100 suitable for practicing an implementation of the subject technology described herein. In the example shown in FIG. 1, system 100 includes a mobile device 110 of a user 102, a mobile device 120 of a user 104, a server 140 and a database 145. Each of mobile devices 110 and 120 are communicatively coupled to server 140 via network 130. Server 140 is communicatively coupled to database 145. Database 145 may be implemented using any computer-readable storage device and may be used to store any type of data that is accessible to server 140. While only server 140 and database 145 are shown in FIG. 1, additional servers and/or databases may be used as desired. Also, while only mobile devices 110 and 120 are shown in FIG. 1, the content delivery service may be provided to any number of mobile devices over network 130.

In an example, server 140 is used to host a content delivery service for providing targeted content to mobile devices 110 and 120 of users 102 and 104, respectively, via network 130. The targeted content provided to each device may be related generally to the specified region or to one or more particular points of interest located within the specified region. Database 145 in this example may be used to store the targeted content in addition to other types of data associated with the target region. In an example, data stored in database 145 for the specified region includes, but is not limited to, content and location data associated with one or more predefined content-filter areas of the target region. As will be described in further detail below, such predefined content-filter areas may be used by the content delivery service to filter targeted content provided to mobile devices 110 or 120 based on the current location of each device relative to a predefined content-filter area within the specified region. In a further example, as will be described in further detail below, the targeted content provided for each predefined content-filter area may be related to a point of interest corresponding to the particular content-filter area.

Server 140 can be implemented using any general-purpose computer capable of serving data to any of mobile devices 110 and 120 or other computing devices (not shown). Examples of computing devices that may be used to implement server 140 include, but are not limited to, a web server, an application server, a proxy server, a network server, or a group of computing devices in a server farm.

Network 130 can be any network or combination of networks that can carry data communication. Such a network can include, but is not limited to, a wired (e.g., Ethernet) or a wireless (e.g., Wi-Fi, 3G or 4G) network. In addition, network 130 can include, but is not limited to, a local area network, medium area network, or wide area network such as the Internet. Network 130 can support protocols and technology including, but not limited to, Internet or World Wide Web protocols and/or services. While not shown in FIG. 1 for ease of discussion, system 100 may include any number of intermediate network routers, gateways, or servers between the various network elements of system 100, as desired for a particular implementation. In some implementations, network 130 may further include a corporate network (e.g., intranet) and one or more wireless access points that each of mobile devices 110 and 120 can use to communicate with server 140 via, for example, a virtual private network (VPN), Secure Shell (SSH) tunnel, or other secure network connection.

Mobile devices 110 and 120 each can be any type of mobile computing device having one or more processors, a memory, a user input device (for example, QWERTY keyboard, a touch-screen, microphone, or a T9 keyboard), a communications infrastructure capable of receiving and transmitting data over a network, and a display (e.g., a touch-screen light-emitting diode (LED) or liquid crystal display (LCD) display). Examples of such mobile computing devices include, but are not limited to, a mobile phone, a personal digital assistant (PDA), a laptop/notebook computer, a tablet computer, a netbook computer, or other type of mobile device capable of processing instructions and receiving and transmitting data to and from users or other computing devices. Software executable at each device may include an operating system and one or more application programs.

As shown in FIG. 1, mobile device 110 executes a client application 115 and mobile device 120 executes a client application 125. As will be described in further detail below with respect to FIG. 2, each of client applications 115 and 125 may be configured to provide users 102 and 104 of mobile devices 110 and 120, respectively, with content associated with one or more points of interest located within a particular geographic region. In some implementations, client applications 115 and 125 may also provide each user with a graphical user interface for accessing the functionality of the content delivery service hosted at server 140. Mobile devices 110 and 120 each may execute a different implementation of the same client application depending on the particular type or computing platform of each device. Thus, client applications 115 and 125 executable at mobile devices 110 and 120, respectively, are configured to provide the same or similar type of functionality for the content delivery service hosted at server 140 via network 130, as described above. In addition to server 140, each of client applications 115 and 125 may be configured to send and receive information to and from each other or similar applications executable at other computing devices (not shown) via network 130. As described above, such information may include, for example and without limitation, content and location data associated with one or more points of interest located within a geographic region.

In the example shown in FIG. 1, each of client applications 115 and 125 executable at mobile devices 110 and 120, respectively may be configured to request targeted content from server 140 via network 130 based on a current location of each device relative to a predefined content-filter area within the target region. As described above, the requested content may be related to a point of interest corresponding to the predefined content-filter area. Client applications 115 and 125 may each determine the current geographic location of mobile devices 110 and 120, respectively, based on, for example, location data obtained from one or more sources of location data. Examples of such sources include, but are not limited to, GPS, cellular towers of a wireless or mobile communication network, or Wi-Fi access points. Thus, mobile devices 110 and 120 may each include one or more different types of network communication interface component(s) for enabling communications (e.g., cellular or wireless Internet (WiFi) communications) through different types of wireless or mobile communication networks or utilizing such networks to derive geographic location data.

Thus, each of mobile devices 110 and 120 may be equipped with, for example, a GPS unit for acquiring location data through geo-positioning signals received from one or more orbiting GPS satellites. The location data acquired for each of mobile devices 110 and 120 may be in the form of latitude and longitude coordinates, e.g. as registered by the GPS of each device with a timestamp for a particular geographic location. Additionally or alternatively, the location data for each mobile device may be acquired from or with the assistance of a network location provider, e.g., a wireless carrier or operator of a mobile or cellular communication network. The acquired location data in this example may then be used by each client application to determine the current geographic location of the respective mobile device.

In a different example, the acquired location data for each of mobile devices 110 and 120 may be reported to server 140 (or content delivery service hosted at server 140) via network 130. The location data may then be used by server 140 to determine or estimate the respective current geographic locations of mobile devices 110 and 120 and based on the determined/estimated current geographic location of each device relative to a content-filter area (e.g., corresponding to a point of interest), provide targeted content related to the content-filter area (e.g., related to the point of interest to which the area corresponds) to each device via network 130.

In some implementations, the location data associated with a user may be processed such that an individual user's identity remains anonymous. Additionally, the user may be provided an option to enable or disable the use of such location data by the content delivery service or associated client application executable at the user's mobile device. For example, each of mobile devices 110 and 120 may provide users 102 and 104, respectively, with configurable options to enable or disable location-tracking capabilities of individual applications, e.g., client application 115 and 125, or of the device altogether. Such configurable options may be provided to users 102 and 104 via, for example, a settings panel of a configuration screen at the device.

FIG. 2 is a block diagram of an example mobile device 200 for filtering or customizing targeted content for a user of mobile device 200 based on a current geographic location of the device (and user) relative to a particular location or point of interest within a geographic region. As shown in FIG. 2, device 200 includes a display 202, a user input device 204, a client application 210, a network interface 220 and a memory 230. For purposes of discussion, mobile device 200 will be described in the context of system 100 of FIG. 1, as described above, but mobile device 200 is not intended to be limited thereto. Thus, mobile device 200 may be implemented using, for example, either of mobile devices 110 or 120 of system 100, as described above. Similarly, client application 210 may be implemented using, for example, client application 115 or 125 of FIG. 1. Memory 230 may be implemented using any type of storage medium for storing different types of content or data. As will be described in further detail below, memory 230 may be used to store any type of data including, for example and without limitation, region data 232 related to a particular geographic region and user data 234 related to the user of mobile device 200.

While not shown in FIG. 2, mobile device 200 may include additional components or subcomponents for implementing the subject technology described herein. For example, network interface 220 of mobile device 200 may include a number of different communication interfaces for providing support for different types of wireless communication networks using a number of different types of wireless communication protocols. Examples of such other network interfaces may include, but are not limited to, GPS, Wi-Fi, cellular, and Bluetooth.

In the example shown in FIG. 2, client application 210 includes a location manager 212, a content manager 214, and a user interface (UI) manager 216. Client application 210 may be implemented as, for example, a standalone or dedicated application associated with the content delivery service. In a different example, client application 210 may be implemented as a web application or service that is accessible through a web browser (not shown) executable at mobile device 200. In the latter example, client application 210 may implemented as, for example, a plug-in for the browser or as application code executable within the browser or a separate browser plug-in. As will be described in further detail below, client application 210 may use, for example, network interface 220 of mobile device 200 to request content related to a location or point of interest within a target region or target region from a content delivery service hosted at the application server via a network, e.g., network 130 of FIG. 1, as described above.

In one example, location manager 212 of client application 210 is configured to determine or estimate a current geographic location of mobile device 200 based on location data received via network interface 220 from one or more sources through one or more communication networks. As described above, such sources of location data may include, but are not limited to, GPS, Wi-Fi, and cellular towers of a mobile communication network. The accuracy of the current geographic location determined for mobile device 200 may vary depending on, for example, the particular source of location data that is used. In general, location data obtained from a GPS (not shown) of mobile device 200 is relatively more accurate than location data obtained from Wi-Fi or cell ID, e.g., via Wi-Fi and cellular network interfaces (also not shown) of mobile device 200. However, since GPS generally requires an unobstructed line of sight to one or more orbiting GPS satellites to receive geo-positioning signals, location manager 212 may have to rely on other sources of location data, such as Wi-Fi or cellular towers instead. Thus, location manager 212 may obtain location data from Wi-Fi or cellular towers when, for example, mobile device 200 does not have an unobstructed line of sight to receive accurate location data through GPS. In other instances, location manager 212 may use a last known or previously determined geographic location for mobile device 200, e.g., which may be stored in memory 230.

In order to improve system performance or reduce power consumption of mobile device 200, location manager 212 may be configured to determine or update the current geographic location of mobile device 200 on a periodic basis, for example, at predetermined time intervals. For example, location manager 212 may be configured to update a previously determined geographic location of mobile device 200 only when location manager 212 detects a change in location or movement of mobile device 200 over time. The location change may be detected, for example, between successive predetermined time intervals. Location manager 212 may be configured to detect movement of the device based on motion data received as input from one or more sensors including, but not limited to, an accelerometer or GPS of mobile device 200.

The current geographic location determined or estimated for mobile device 200 is then used by location manager 212 to determine whether or not mobile device 200 is located within a particular geographic region or target region. If location manager 212 determines that mobile device 200 is located within the target region, location manager 212 in this example also determines whether or not mobile device 200 is located within a predefined content-filter area or “do-not zone” of the target region. If location manager 212 determines that mobile device 200 is located within the predefined content-filter area, content manager 214 may filter targeted content related to the predefined content-filter area (or point of interest to which it corresponds) by not requesting content related to the content area (or corresponding POI). Alternatively, content manager 214 may send a request to the application server for targeted content customized specifically for mobile device users located within the content area.

However, if location manager 212 determines that mobile device 200 is not located within the predefined content-filter area, content manager 214 sends a request for content to an application server (e.g., server 140 of FIG. 1, as described above) via a network (e.g., network 130 of FIG. 1, as described above). The request may be in the form of, for example, a standard Hypertext Transfer Protocol (HTTP) request message over the network. However, the techniques described herein are not limited thereto, and the request may be sent using any of various network communication protocols.

The predefined content-filter area in this example may correspond to a point of interest located within the geographic region. Content requested by content manager 214 may be related to a point of interest associated with the predefined content-filter area the application server may be used to host a content delivery service for providing targeted content to mobile device users based on their respective geographic locations within the particular geographic region, e.g., as long as such users are not located within a predefined content-filter area. Content received from the application server or content delivery service based on the request by content manager 214 may be stored in memory 230 or provided to the user via display 202. In an example, UI manager 216 is configured to provide the received content to the user of mobile device 200 via, for example, a graphical user interface of client application 210.

In a further example, the point of interest may be one of multiple points of interest within the target region, and each point of interest may correspond to a different do-not zone. The do-not zone associated with each point of interest may be defined by, for example, a third-party content provider associated with the particular point of interest. Content manager 214 in this example may be configured to request content related to one or multiple points of interest within the particular geographic region. Content manager 214 may request content related to each point of interest located within the geographic region. However, this may lead to reduced system performance and increased network latency if, for example, the geographic region includes a relatively large number of points of interest. Thus, content manager 214 may be configured to request content for only a predetermined number of points of interest. Such a predetermined threshold quantity may be based on a value specified by, for example, the content delivery service provider or user of mobile device 200. In some implementations, the predetermined threshold quantity may be a configurable option in a user settings panel provided by, for example, UI manager 216 for an interface of client application 210.

In some implementations, content manager 214 may be further configured to request content for only those points of interest located within a predetermined distance threshold or proximity radius of the current geographic location of mobile device 200. Content manager 214 may identify one or more points of interest located within the predetermined proximity radius and then determine whether or not the number of identified points of interest exceeds a predetermined limit or threshold value, as described above. If the number of identified points of interest exceeds the predetermined limit, content manager 214 may select the identified points of interest that are located nearest to the current geographic location of mobile device 200 The location of each point of interest within the geographic region may be stored in memory 230 as, for example, region data 232. Upon determining that mobile device 200 is located within the particular geographic region, as described above, content manager 214 may use network interface 220 to send a request for region data 232 to the content delivery service hosted at the application server via the network. Content manager 214 may then determine whether or not mobile device 200 is located within any of the predetermined do-not zones corresponding to the identified points of interest, and request data related to only those points of interest associated with do-not zones in which the user is determined not to be located.

In a further example, content manager 214 selects different points of interest based on user data 234 stored in memory 230 at mobile device 200. User data 234 may include, for example, a record of various user-selected content over a predetermined time period of using client application 210. Such data may be captured via a graphical user interface (GUI) of client application 210, as provided to the user by UI Manager 216. User data 234 may also include location history including a record of previous locations or points of interest visited by the user over a period of time. User data 234 may also be stored in association with a profile or account stored for the user at the application server (e.g., server 140 of FIG. 1) hosting the content delivery service, as described above. Content manager 214 may include information identifying the user in the request for content sent to the application server. The application server in this example may then identify the user based on the information included in the request. The application server then provides content that may be customized for the identified user based on the user's profile stored at the server or a local data store or database (e.g., database 145 of FIG. 1, as described above) coupled to the server.

In some implementations, UI manager 216 is configured to display a digital map of the target region for the user via display 202. The displayed map may be based on, for example, map data or other reference information associated with the particular geographic region. Content manager 214 in this example may be configured to request map data of the target region from, for example, a third-party mapping service via a network (e.g., network 130 of FIG. 1, as described above). Such map data may be stored in memory 230 of mobile device 200 as region data 232. Region data 232 may also include region data including locations of geographic features and points of interest for the target region. Such region data may be acquired by content manager 214 over the network from the application server hosting the above-described content-delivery service. UI manager 216 can use region data 232 to display a graphical representation of the reference map including the geographic features and points of interest. UI manager 216 may also display visual markers identifying the current geographic location of mobile device 200 as well as the respective locations of one or more points of interest.

FIG. 3 illustrates an example of a target region 300 including a predefined content-filter area or “do-not zone” 310. Do-not zone 310 in this example is used for filtering targeted content for users of mobile devices 302 and 304 based on the respective locations of mobile devices 302 and 304 within target region 300 relative to do-not zone 310. Target region 300 may represent, for example, a particular city or town. However, target region 300 is not intended to be limited thereto and may correspond to a predetermined geographic region of any size and shape. In a further example, target region 300 may be predefined area of a relatively larger geographic, which also includes a second predefined area corresponding to content-filter area or do-not zone 310.

Also, do-not zone 310 may correspond to, for example, a point of interest (not shown) located within target region 300. Accordingly, the boundaries of do-not zone 310 may be based on, for example, a predetermined proximity radius or distance relative to the location of the point of interest. The boundaries of do-not zone 310 may be customized as desired by, for example, a content provider associated with the point of interest. The predefined content-filter area for do-not zone 310 may be implemented as a geo-fenced area or virtual perimeter around the point of interest.

FIG. 4 illustrates an example of a geographic region 400 including multiple do-not zones corresponding to different points of interest (POI) within the region. As shown in the example of FIG. 4, each do-not zone is a separate predefined content-filter area for each point of interest within region 400. In an example, region 400 may be designated as the target region for providing targeted content to mobile device users 402 and 404 located within the region.

Also, as shown in FIG. 4, a portion of region 400 has been designated to be a separate target region 410 for a particular POI 412. Accordingly, different targeted content may be provided to mobile device users 402 and 404 based on the respective locations of each user's mobile device within region 400 and relative to do-not zone 414 of POI 412. As shown in FIG. 4, a portion of target region 410 may be designated as a do-not zone 414 for POI 412. Do-not zone 414 in this example is a predefined content-filter area of target region 410. As described above, target region 410 and do-not zone 414 may be implemented as geo-fenced areas of a predetermined size and shape within geographic region 400.

While target region 410 and do-not zone 414 are shown in FIG. 4 as circular regions, it should be noted that the techniques disclosed herein are not intended to be limited thereto and that each target region or do-not zone may be a predefined area of any size and shape. For example, the shape of a do-not zone may be customized so as to form a virtual perimeter corresponding to the shape of a building or physical structure of the particular point of interest. As shown in FIG. 4, the shape of a do-not zone 424 for a POI 422 representing a museum located within geographic region 400 is customized to match the shape of the museum building.

FIG. 5 is a process flowchart of an exemplary method 500 for filtering targeted content for mobile device users based on their current locations relative to a point of interest within a geographic region. For purposes of discussion, method 500 will be described using network system 100 of FIG. 1 and mobile device 200 (including client application 210) of FIG. 2, as described above. However, method 500 is not intended to be limited thereto. The steps of method 500 may be implemented using, for example, client application 210 (including location manager 212, content manager 214 and UI manager 216) of FIG. 2, as described above.

Method 500 begins at step 502, which includes determining or estimating a current geographic location of a user's mobile device. The current location of the mobile device may be determined or estimated based on location data obtained from one or more sources of such data including, but not limited to, GPS, Wi-Fi and cellular towers, as described previously. Method 500 then proceeds to steps 504 and 506, which includes determining whether or not the current geographic location of the mobile device, as determined in step 502, is within a target region. The target region may be a predetermined geographic region corresponding to, for example, a particular city/town or portion thereof but is not limited thereto. In an example, the target region includes one or more points of interest at various locations within the target region. Further, each point of interest may be associated with a predefined content-filter area (or do-not zone, as described above) of a relatively smaller size within the target region. The predefined content-filter area in this example may be used to filter or customize targeted content for the mobile device user based on the current location of the user's mobile device obtained in step 502 relative to, for example, a predetermined boundary of the predefined content-filter area or the point of interest to which it corresponds. If the mobile device is determined to be located within the target region, method 500 proceeds to step 508. Otherwise, method 500 concludes after step 506.

In step 508, upon determining that the mobile device is located within the target region (at step 504), it is determined whether or not the mobile device is located within a predefined content-filter area corresponding to at least one point of interest located within the target region. As shown in FIG. 5, method 500 concludes after proceeding to step 510 if the mobile device is determined to be located within the predefined content-filter area. However, if the mobile device is determined not to be located within the predefined content-filter area, method 500 proceeds to step 512, in which content related to the point of interest is requested from a server (e.g., server 140 of FIG. 1, as described above) via a network (e.g., network 130 of FIG. 1, as described above). In some implementations, content for multiple points of interest may be requested, where the mobile device is determined (at step 508) not to be located in any of the respective predefined content-filter areas or do-not zones corresponding to the particular points of interest.

Once the requested content is received from the server, method 500 proceeds to step 514, in which content received from the server is provided to the user at the mobile device. In an example, the content may be displayed to the user via a graphical user interface of a client application executable at the mobile device. In a different example, the content may be provided to the user as a notification message in a dialog window displayed to the user via a display of the mobile device.

While not shown in FIG. 5, method 500 may include additional steps for determining that the location of the mobile device within the target region has changed and requesting content related to one or more other points of interest based on the new location of the mobile device not being within any of the predetermined do-not zones corresponding to the other point(s) of interest. The content

Aspects of the techniques described herein and as shown in FIGS. 1-5, or any part(s) or function(s) thereof, may be implemented using hardware, software modules, firmware, tangible computer readable media having instructions stored thereon, or a combination thereof and may be implemented in one or more computer systems or other processing systems.

FIG. 6 is a block diagram of an example computer system 600 in which portions of the subject technology can be implemented. It is believed that the structure, programming and general operation of such computer equipment and as a result the drawings should be self-explanatory. Computer system 600 can be a computer, phone, PDA, or any other sort of electronic device. System 600 includes various types of computer readable media and interfaces for various other types of computer readable media. As shown in HG. 6, system 600 includes a bus, a processor or central processing unit (CPU), a read-only memory (ROM), a system memory or random-access memory (RAM), a network interface, a permanent storage device, an input/output device interface coupled to an output device (e.g., a display), and an input device (e.g., a mouse or keyboard).

Computer system 600 includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

Hence, aspects of the various network components of the mobile communication networks of FIG. 1, as described above, may be embodied in programming. Program aspects of the technology may be thought of as “products” or “articles of manufacture” typically in the form of executable code or process instructions and/or associated data that is stored on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of a web application/service provider into the computer platform of the application or web server that will be hosting the web application/service.

Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible storage media, terms such as “computer’ or “machine readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the functions performed by the various network components of FIG. 1 and FIG. 2, as described above. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM. DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

As noted above, the computer as illustrated in the example of FIG. 6 may be a mobile computer with user interface elements, as may be used to implement a laptop, tablet or notebook computer or the like. For example, such a device may include a touch-screen display for user input and output. Alternatively, the device may include a standard light emitting diode (LED) display and, for example, an alphanumeric keypad or T9 keyboard. It is believed that the structure, programming, and general operation of such computing equipment and as a result the drawing should be self-explanatory. As known in the data processing and communications arts, a mobile computer comprises a central processor or other processing device, an internal communication bus, various types of memory or storage media (RAM, ROM, EEPROM, cache memory, disk drives, etc.) for code and data storage, and one or more network interface cards or ports for communication purposes. Also, the mobile computer can further comprise various wireless transceiver modules (or components) such as GPS, WiFi, IrDA. Bluetooth, etc. The software functionalities involve programming, including executable code, associated stored data, and graphical user interface code for implementing a client application program at the mobile device. The software code is executable by the processor of the mobile computer. In operation, the code is stored within the mobile computer. At other times, however, the software may be stored at other locations and/or transported for loading into the appropriate mobile computer. Execution of such code by a processor of the mobile computer enables the mobile computer to implement the methodology for a client for displaying an incoming call screen including image data and other call-specific information in response to an incoming call notification or page, in essentially the manner performed in the implementation discussed and illustrated herein.

Further, the client can be implemented in a remote computer (or server) on a network. That is, a client device (e.g., mobile device) sends information (e.g., a request message) to the remote server for requesting access to a function of a web application hosted at the server; and the remote server processes the request based on the request received from the client and returns an appropriate response (e.g., including application data retrieved from a database) to the client over the network. In the example above, the client device operates as a client terminal and the remote computer as a server in a client-server network environment.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method for filtering targeted content for mobile device users, comprising:
determining a current geographic location of a mobile device of a user;
determining whether or not the mobile device is located within a target region based on the determined current geographic location of the mobile device, the target region including at least one point of interest located within the target region;
when the mobile device is determined to be located within the target region, determining whether or not the mobile device is located within a predefined content-filter area corresponding to the point of interest of the target region;
when the mobile device is determined not to be located within the predefined content-filter area, sending a request to a server for content related to the point of interest within the target region; and
displaying, to a display of the mobile device, the content received from the server in response to request.

2. The method of claim 1, wherein the information related to the point of interest is provided by a content-delivery service hosted at the application server.

3. The method of claim 1, wherein the point of interest is one of multiple points of interest located within the target region and each of the multiple points of interest corresponds to a different predefined content-filter area within the target region.

4. The method of claim 3, wherein the determination of whether or not the mobile device is located within the predefined content-filter area comprises:
identifying one or more of the multiple points of interest within the target region that are located within a predetermined distance of the current geographic location of the mobile device; and
determining whether or not the mobile device is located within at least one of the predefined content-filter areas corresponding to the identified points of interest within the target region,
wherein the information requested from the application server is related to each of the identified points of interest for which the mobile device is determined not to be located within the corresponding predefined content-filter area.

5. The method of claim 4, wherein the predetermined distance is calculated based on a difference between the current geographic location of the mobile device and a nearest boundary of each predefined content-filter area corresponding to the respective multiple points of interests within the target region.

6. The method of claim 5, further comprising:
determining whether a total number of the identified points of interest located within the predetermined distance of the current geographic location of the mobile device exceeds a predetermined threshold value; and
selecting points of interest from among the identified points of interest such that the total number of the selected points of interest is less than the predetermined threshold value, when the total number of the identified points of interest is determined to exceed the predetermined.

7. The method of claim 6, wherein the points of interest are selected based on a relative proximity of the nearest boundary of each predefined content-filter area corresponding to the identified points of interest.

8. The method of claim 6, wherein the points of interest are selected based on a profile of the user at the mobile device, the request to the application server includes information related to the profile of the user and the content received from the application server is customized based on the information related to the user's profile.

9. The method of claim 4, wherein the current geographic location of the mobile device is determined on a periodic basis at predetermined time intervals.

10. The method of claim 9, further comprising:
upon determining a change in the current geographic location of the mobile device between successive predetermined time intervals, repeating the identifying, determining and providing steps based on the determined change in the current geographic location of the mobile device.

11. The method of claim 1, further comprising:
acquiring region data including locations of geographic features and points of interest for the target region;
determining a relative position of each feature and point of interest on the digital map based on the acquired region data;
displaying a graphical representation of at least a portion of the digital map using a display of the mobile device based on the determination; and
displaying a graphical representation of the geographic features and the points of interest corresponding to the displayed portion of the digital map.

12. A computer-implemented method for filtering customized content for mobile device users based on their current locations relative to a geographic region of interest, comprising:
determining a current geographic location for a mobile device of a user;
upon determining whether the mobile device is located within a predetermined geographic area based on the current geographic location determined for the mobile device, determining whether or not the mobile device is located within at least one geographic region of interest located within the predetermined geographic area;
when the mobile device is determined not to be located within the geographic region of interest, sending a request to an application server for content associated with the geographic region of interest; and
upon receiving content from the application server based on the request, providing the received content to the user at the mobile device.

13. A system, comprising:
at least one processor; and
a memory device accessible to the processor, the memory device including processor-readable instructions, which when executed by the processor, configure the processor to perform functions to:
determine a current geographic location of a mobile device of a user;
determine whether or not the mobile device is located within a target region based on the determined current geographic location of the mobile device, the target region including at least one point of interest located within the target region;
when the mobile device is determined to be located within the target region, determine whether or not the mobile device is located within a predefined content-filter area corresponding to the point of interest of the target region;
when the mobile device is determined not to be located within the predefined content-filter area, send a request to a server for content related to the point of interest within the target region; and
display content received from the server to a display of the mobile device.

14. The system of claim 13, wherein the information related to the point of interest is provided by a content delivery service hosted at the application server.

15. The system of claim 13, wherein the point of interest is one of multiple points of interest located within the target region and each of the multiple points of interest corresponds to a different predefined content-filter area within the target region.

16. The system of claim 15, wherein the function to determine whether or not the mobile device is located within the predefined content-filter area configures the processor to perform additional functions, including functions to:
identify one or more of the multiple points of interest within the target region that are located within a predetermined distance of the current geographic location of the mobile device; and
determine whether or not the mobile device is located within at least one of the predefined content-filter areas corresponding to the identified points of interest within the target region,
wherein the information requested from the application server is related to each of the identified points of interest for which the mobile device is determined not to be located within the corresponding predefined content-filter area.

17. The system of claim 16, wherein the predetermined distance is calculated based on a difference between the current geographic location of the mobile device and a nearest boundary of each predefined content-filter area corresponding to the respective multiple points of interests within the target region.

18. The system of claim 13, wherein the functions performed by the processor include functions to:
determine whether a total number of the identified points of interest located within the predetermined distance of the current geographic location of the mobile device exceeds a predetermined threshold value; and
select points of interest from among the identified points of interest such that the total number of the selected points of interest is less than the predetermined threshold value, when the total number of the identified points of interest is determined to exceed the predetermined.

19. The system of claim 18, wherein the points of interest are selected based on a relative proximity of the nearest boundary of each predefined content-filter area corresponding to the identified points of interest.

20. A computer-readable storage medium having instructions stored thereon, which when executed by a processor of a mobile computing device cause the mobile computing device to perform functions comprising:
determining a current geographic location for a mobile device of a user;
determining whether the mobile device is located within a target region based on the determined current geographic location of the mobile device, the target region including a plurality of points of interest at different locations within the target region, each point of interest corresponding to a different predefined content-filter area within the target region;
when the mobile device is determined to be located within the target region, identifying one or more of the plurality of points of interest within the target region that are located within a predetermined distance of the current geographic location of the mobile device;
determining whether or not the mobile device is located within a predefined content-filter area corresponding to each of the identified one or more points of interest within the target region;
when the mobile device is determined not to be located within a predefined content-filter area corresponding to each of the identified one or more points of interest, sending a request to an application server for information related to each of the identified one or more points of interest; and
responsive to receiving information from the application server based on the request, providing the received information to the user via a client application executable at the mobile device.
